(19) United States
(12) Patent Application Publication
(10) Pub. No.: US 2018/0255693 A1
(43) Pub. Date: Sep. 13, 2018

(54) Polyfunctional Tool

(71) Applicant: James Dillon Bonner, San Antonio, TX (US)

(72) Inventor: James Dillon Bonner, San Antonio, TX (US)

(21) Appl. No.: 15/683,738

(22) Filed: Aug. 22, 2017

Related U.S. Application Data
(60) Provisional application No. 62/378,197, filed on Aug. 22, 2016.

(51) Int. Cl. A01B 1/02; B25F 1/00; B26B 11/00

(52) U.S. Cl. CPC A01B 1/022; B26B 11/006; B25F 1/00

(57) ABSTRACT

Disclosed is a hand held implement for performing a multitude of tasks in a manner which could not previously be performed by a singular hand held implement. Some exemplary embodiments of the present invention comprise a handle, shovel, blade, hammer and prying member configured in an ideal manner. This ideal configuration provides a hand held implement in which the safety, functionality and efficiency of use is greater than was previously provided by the state of the art. A proximal end of the present invention preferably comprises a prying member. A distal end of the present invention preferably comprises a shovel. A forward portion of the present invention preferably comprises a blade disposed along said shovel and extending towards said proximal end. A rearward portion of the present invention preferably comprises a hammer disposed along said shovel.

### CROSS REFERENCE TO RELATED APPLICATION

The present Application claims priority of U.S. Application No. 62/378,197 filed Aug. 22, 2016 by the present inventor, titled: Polyfunctional Tool.

### FEDERALLY SPONSORED RESEARCH

None

### SEQUENCE LISTING

None

### FIELD OF THE INVENTION

The present invention relates to hand held tools. More specifically, the present invention relates to multifunctional hand held tools which comprise a shovel.

### BACKGROUND OF THE INVENTION

Militaries utilize a variety of hand held tools, these hand held tools are often specialized for either wilderness environment tasks or urban environment tasks. This specialization of hand held tools is due to particular environments presenting the soldier with specific tasks to be performed which are not typical to all environments.

Typical wilderness environment tasks include, but are not limited to:

(a) Shoveling

(b) Cutting

(c) Chopping

(d) Sawing wood

Typical urban environment tasks include, but are not limited to:

(a) Hammering

(b) Prying

(c) Raking

(d) Sawing metal

Most militaries utilize some sort of hand held entrenching tool. State of the art hand held entrenching tools are typically comprised of a shovel, blade and wood saw, and therefore, these state of the art hand held entrenching tools are capable of performing the aforementioned typical wilderness environment tasks. However, these state of the art hand held entrenching tools lack a hammer, prying member, rake and metal cutting saw, and therefore are not ideally suited to perform the aforementioned typical urban environment tasks. Because state of the art hand held entrenching tools are not ideally suited to perform the aforementioned typical urban environment tasks, soldiers operating in urban environments often choose to utilize a variety of hand held implements which are specialized to perform these tasks in lieu of utilizing the state of the art hand held entrenching tool.

Furthermore, the aforementioned features of shovel, blade and wood saw are not configured in an ideal manner on the state of the art hand held entrenching tools, and therefore, those tasks which are performed with state of the art hand held entrenching tools are done so in a manner which is less safe, less functional and less efficient than if these features were configured in the ideal manner.

The ideal hand held entrenching tool would comprise a shovel, blade, wood saw, hammer, prying member, rake and metal saw and would therefore be ideally suited for both the typical wilderness environment tasks and the typical urban environment tasks. Furthermore, the aforementioned features of shovel, blade, wood saw, hammer, prying member, rake and metal saw would be configured about this ideal hand held entrenching tool in an ideal manner such that tasks which are performed with this ideal hand held entrenching tool are performed in a manner which provides the highest level of safety, functionality and efficiency of use. Despite this need, the state of the art does not provide for a hand held entrenching tool which comprises features which are ideally suited for performing both the typical wilderness environment tasks and the typical urban environment tasks, and furthermore, the state of the art does not provide for a hand held entrenching tool with features which are configured in the ideal manner.

With these facts identified it is clear that the state of the art for hand held entrenching tools is lacking. No hand held entrenching tool has previously existed which is ideally suited for performing both the typical wilderness environment tasks and the typical urban environment tasks, nor has a hand held entrenching tool previously existed which provides its features in the ideal configuration such the the user is provided a hand held entrenching tool with the highest level of safety, functionality and efficiency of use.

### BRIEF SUMMARY OF THE INVENTION

The present invention was developed in response to the present state of the art, and in particular, in response to the problems and needs in the state the art that have not yet been fully solved by the hand held entrenching tool instruments and methods currently available. In accordance with the present invention as embodied and broadly described herein in the embodiments, a hand held entrenching tool with increased safety, functionality and efficiency of use is provided. The present invention is the long awaited solution to many of the inherent problems and difficulties in hand held entrenching tools by providing the user a hand held entrenching tool with a number of features which are ideally configured about the tool, these features being ideally suited to perform both the typical wilderness environment tasks and the typical urban environment tasks.

In one exemplary embodiment the present invention may be described as a hand held entrenching tool with increased safety, functionality, and efficiency of use as detailed herein. The present invention has a number of advantages when compared to the state of the art. These advantages include but are not limited to:

a) One exemplary embodiment of the present invention provides the user a hand held entrenching tool which comprises a shovel, blade, hammer, prying member, rake, wood saw and metal saw such that the user is provided a singular hand held entrenching tool which is ideally suited to perform the typical wilderness environment tasks of shoveling, cutting, chopping and sawing wood as well as the typical urban environment tasks of hammering, prying, raking and sawing metal.

b) One exemplary embodiment of the present invention provides the user a hand held entrenching tool which is ideally suited to performing both the typical wilderness environment tasks and the typical urban environment tasks, and therefore, the present invention provides the user a significant decrease in both weight and dimension in comparison to the assortment of state of the art tools required to perform these same tasks.

c) One exemplary embodiment of the present invention provides the user a hand held entrenching tool which comprises a blade. This blade comprising a first portion of the blade and second portion of the blade. This first portion of the blade not being intended to engage the material to be shovelled when the shovel function of the present invention is utilized, and therefore, the sharpened edge of this first portion of the blade is not dulled by engagement with the material to be shovelled. Therefore, the sharpened edge of this first portion of the blade is preserved such that cutting and chopping capability is maintained.

d) One exemplary embodiment of the present invention provides the user with a hand held entrenching tool comprising an angled blade. This angled blade provides an increased cutting and chopping ability by increasing the forward reach of the blade, reducing the likelihood of the blade deflecting on impact and shifting the center of blade mass toward the end of the blade when compared to a non-angled blade of equivalent length and thickness.

e) One exemplary embodiment of the present invention provides the user with a hand held entrenching tool comprising an angled handle. Proper usage of the present invention for the task of hammering involves the user gripping the outermost portion of this angled handle. This gripping of the outermost portion of the angled rehandle causes the shovel to be inclined at an angle. This incline of the shovel allows the shovel to deflect a significant portion of the impact force which would otherwise be transmitted into the shovel due to impact. Therefore, when compared with the state of the art, the angled handle configuration of the present invention reduces damage to the shovel.

f) One exemplary embodiment of the present invention provides the user with a hand held entrenching tool with an angled handle. This angled handle providing the user the ability to properly perform the tasks of hammering and prying in a proximity to confining obstacles which could not be previously performed by state of the art handheld entrenching tools.

g) One exemplary embodiment of the present invention provides the user with the ability to simultaneously grip the present invention by multiple axis. This ability to simultaneously grip multiple axis provides the user with improved control of the present invention when compared to state of the art hand held entrenching tools.

h) One exemplary embodiment of the present invention provides a hand held entrenching tool comprising a crossmember. This crossmember providing the user with a hand hold which is proximal to the shovel. This crossmember, therefore, allows an alternate gripping technique to be utilized which provides superior ergonomics in those instances where the user utilizes the shovelling function in confined spaces. Furthermore, this crossmember provides increased rigidity to the hammer body to reduce damage inflicted to the present invention during the task of shovelling.

i) One exemplary embodiment of the present invention provides a hand held entrenching tool with an uninterrupted blade which extends along one side of a shovel. This uninterrupted blade extending past this side of the shovel such that the blade is significantly longer than the side of the shovel upon which it extends. This blade configuration provides the user with increased cutting and chopping capability compared to state of the art entrenching tools.

j) One exemplary embodiment of the present invention provides a blade configured upon a forward portion and a hammer configured upon a rearward portion. This configuration of the hammer opposite the blade provides enhanced cutting and chopping capability due to the hammer providing additional mass behind the blade.

k) One exemplary embodiment of the present invention provides the user the ability to engage a portion of the hammer body with his or her first finger and second finger in order to provide increased leverage during the task of prying. Such an engagement between the user's first finger, second finger and hammer body providing superior leverage when compared to the state of the art handheld entrenching tools.

l) One exemplary embodiment of the present invention provides a blade and prying member configured upon a forward portion. This configuration of the blade and prying member on the forward portion of the present invention provides that the blade is oriented away for the user while he or she is utilizing the present invention for prying tasks. This orientation of the blade away from the user during prying tasks provides increased safety for the user.

m) One exemplary embodiment of the present invention comprises a rake upon the hammer body which provides a raking function. This raking function being especially useful for dislodging window glass shards from window frames such that the user may cross window thresholds without sustaining injury due to window glass shards.

n) One embodiment of the present invention comprises a saw mounting provision. This saw mounting provision providing the user the ability to attach either a wood saw or a metal saw in order to perform the function of sawing. This saw mounting provision being configured such that the sharpened edge of the blade is oriented away from the user such that increased safety is provided for the user as he or she utilizes this sawing function.

### BRIEF DESCRIPTION OF THE DRAWINGS

In order that the manner in which the above-recited and other features and advantages of the invention are obtained will be readily understood, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 is a left side view of the Polyfunctional Tool 1.

FIG. 2 is a left side exploded view of Polyfunctional Tool 1.

FIG. 3 is a left side view of the Polyfunctional Tool 1.

FIG. 4 is a right side view of the Polyfunctional Tool 1.

FIG. 5 is a sectional view further illustrating the conditions of FIG. 1.

FIG. 6 is a rear view of the Polyfunctional Tool 1.

FIG. 7 is a left side view of the Polyfunctional Tool 1 and front view of the user which illustrates a first step of utilizing the Polyfunctional Tool 1 for the task of shoveling.

FIG. 8 is a left side view of the Polyfunctional Tool 1 and front view of the user which illustrates a second step of utilizing the Polyfunctional Tool 1 for the task of shoveling.

FIG. 9 is a left side view of the Polyfunctional Tool 1 and front view of the user which illustrates a third step of utilizing the Polyfunctional Tool 1 for the task of shoveling.

FIG. 10 is a front view of the Polyfunctional Tool 1 and left side view of the user which illustrates a fourth step of utilizing the Polyfunctional Tool 1 for the task of shoveling.

FIG. 11 is a left side view of the Polyfunctional Tool 1 and top view of the user which further illustrates the fourth step of utilizing the Polyfunctional Tool 1 for the task of shoveling.

FIG. 12 is a left side view of the Polyfunctional Tool 1 and top view of the user which illustrates an alternate gripping method which may be performed by the user while utilizing the Polyfunctional Tool 1 for the task of shovelling.

FIG. 13 is a right side view of the Polyfunctional Tool 1 and top view of the user which illustrates a first step of utilizing the Polyfunctional Tool 1 for the task of hammering.

FIG. 14 is a right side view of the Polyfunctional Tool 1 and top view of the user which illustrates a second step of utilizing the Polyfunctional Tool 1 for the task of hammering.

FIG. 15 is a right side view of the Polyfunctional Tool 1 and left side view of the user which illustrates the Polyfunctional Tool 1 being utilized for the function of raking.

FIG. 16 is a left side view of the Polyfunctional Tool 1 and top view of the user which illustrates the rearward portion of the shovel 48 having impacted an obstruction 35 as the user attempted to impact the wall 30 with the hammer 5.

FIG. 17 is a left side view of the Polyfunctional Tool 1 and top view of the user which illustrates a first step of utilizing the Polyfunctional Tool 1 for the task of cutting or chopping.

FIG. 18 is a left side view of the Polyfunctional Tool 1 and top view of the user which illustrates a second step of utilizing the Polyfunctional Tool 1 for the task of cutting or chopping.

FIG. 19 is a partial left side view of the Polyfunctional Tool 1 which illustrates a technique utilized to properly seat the prying member 4 between the wall 30 and the door 33 as a first step in utilizing the Polyfunctional Tool 1 for the task of prying.

FIG. 20 is a left side view of the Polyfunctional Tool 1 and top view of the user which illustrates a second step of utilizing the Polyfunctional Tool 1 for the task of prying.

FIG. 21 is a left side view of the Polyfunctional Tool 1 and top view of the user which illustrates a third step of utilizing the Polyfunctional Tool 1 for the task of prying.

FIG. 22 is a partial left side view of the Polyfunctional Tool 1 further illustrating the conditions of FIG. 20 and FIG. 21.

FIG. 23 is a left side view of the Polyfunctional Tool 1 being utilized for the task of bottle opening.

FIG. 24 is a partial left side view of the Polyfunctional Tool 1 illustrating a first step of the user attaching the saw 22 to the Polyfunctional Tool 1.

FIG. 25 is a partial sectional view further illustrating the conditions of FIG. 24.

FIG. 26 is a partial left side view of the Polyfunctional Tool 1 illustrating a second step of the user attaching the saw 22 to the Polyfunctional Tool 1.

FIG. 27 is a partial sectional view further illustrating the conditions of FIG. 26.

FIG. 28 is a right side view of the Polyfunctional Tool 1 and left side view of the user which illustrates the Polyfunctional Tool 1 being utilized for the function of sawing.

FIG. 29 is a left side view of the hammer body 23.

FIG. 30 is a right side view of the hammer body 23.

FIG. 31 is a top view of the hammer body 23.

FIG. 32 is a bottom view of the hammer body 23.

FIG. 33 is a front view of the hammer body 23.

FIG. 34 is a rear view of the hammer body 23.

FIG. 35 is a left side view of the prying member body 24.

FIG. 36 is a right side view of the prying member body 24.

FIG. 37 is a top view of the prying member body 24.

FIG. 38 is a bottom view of the prying member body 24.

FIG. 39 is a front view of the prying member body 24.

FIG. 40 is a rear view of the prying member body 24.

### REFERENCE NUMERALS

1. Polyfunctional Tool
2. Shovel
3. Blade
4. Prying member
5. Hammer
6. Rake
7. User's foot
8. User's left hand
9. User's right hand
10. Proximal end
11. Crossmember
12. Finger hole
13. Finger surface
14. Hammering surface
15. Saw mounting provision
16. Saw locking provision
17. Bottle opener
18. Material stop
19. Hand hole
20. Left side handle
21. Right side handle
22. Saw
23. Hammer body
24. Prying member body
25. Saw mounting provision hole
26. Saw locking provision hole
27. Handle portion of the main body
28. First surface of the shovel head
29. Second surface of the shovel head
30. Wall
31. Tree
32. Material to be shovelled
33. Door
34. Bottle
35. Obstruction
36. Window glass shard
37. Upward direction
38. Hammering implement
39. Bottle cap
40. User's first finger
41. User's second finger
42. Downward direction
43. Main body
44. Screw
45. Bolt
46. Saw locking provision clearance slot
47. Saw manipulation hole
48. Rearward portion of the shovel
49. Saw holding tabs
50. Distal end
51. First portion of the handle
52. Second portion of the handle
53. Second portion of the blade
54. First portion of the blade
55. Object to be sawed
56. Clockwise direction
57. Counter-clockwise direction
58. Forward direction
59. Rearward direction
60. Window frame
C. Location of the weld which secures the hammer body to the main body
D. Location of the weld which secures the prying member body to the main body
E. Line extending along the first portion of the blade
F. Line extending along the second portion of the blade
G. Line extending along the first portion of the handle
H. Line extending along the second portion of the handle
K. Forward portion
L. Rearward portion
N. Line extending along the rearward portion of the shovel
P. Angle between line E and line F
Q. Angle between line G and line H

### DETAILED DESCRIPTION OF THE DRAWINGS

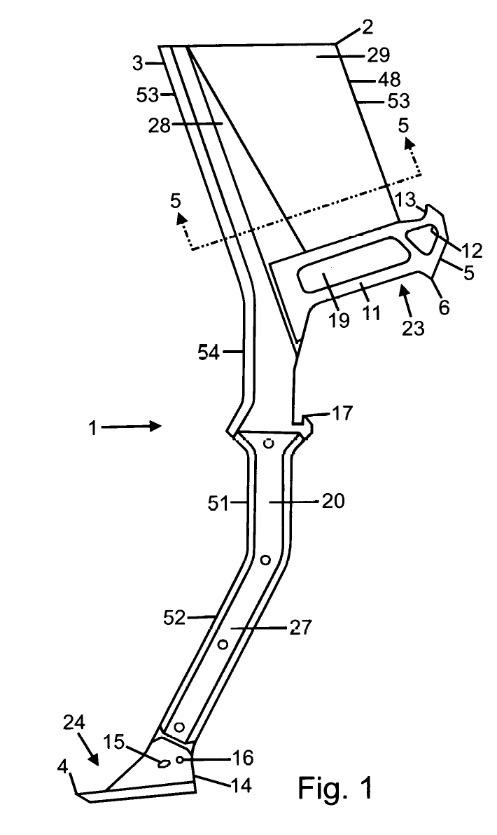

The presently exemplary embodiments of the present invention will be best understood by reference to the drawings, wherein like parts are designated by like numerals throughout. It will be readily understood that the components of the present invention, as generally described and illustrated in the figures herein, could be arranged and designed in a wide variety of different configurations. Thus, the following more detailed description of the embodiments of the apparatus, system, and method of the present invention, as represented in FIGS. 1 through 40, is not intended to limit the scope of the invention, as claimed, but is merely representative of presently exemplary embodiments of the invention.

FIG. 1 is a left side view of the Polyfunctional Tool 1. This Polyfunctional Tool 1 is one embodiment of the present invention. As illustrated in FIG. 1, the Polyfunctional Tool 1 comprises a shovel 2, a blade 3, a hammer 5, a rake 6, a prying member 4 and a saw mounting provision 15. The Polyfunctional Tool 1 may be utilized to perform a number of tasks including, but not limited to: shoveling, hammering, cutting, chopping, prying, raking and sawing, and therefore, the Polyfunctional Tool 1 is able to perform both the aforementioned typical wilderness environment tasks and typical urban environment tasks.

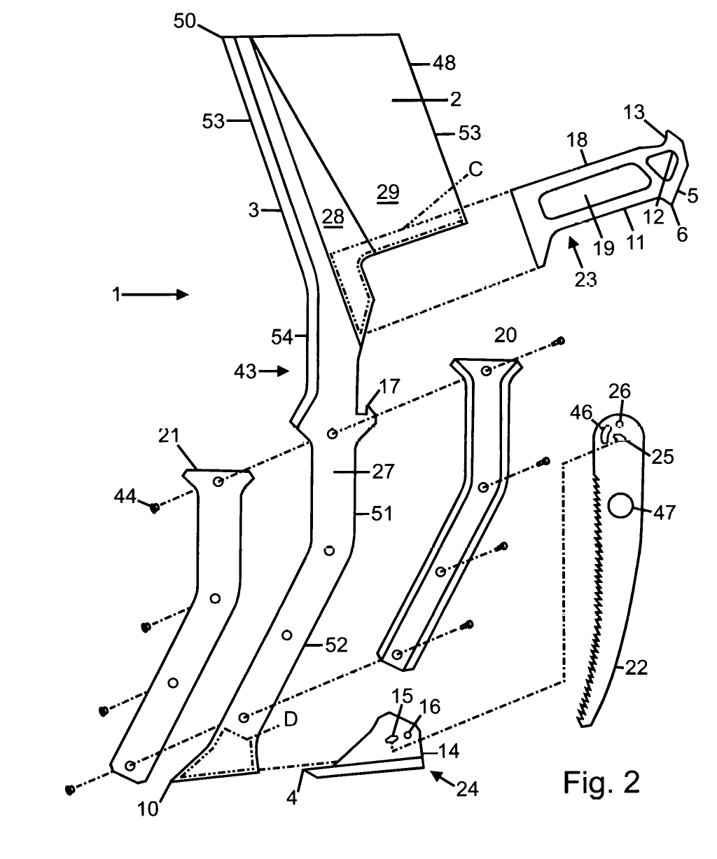

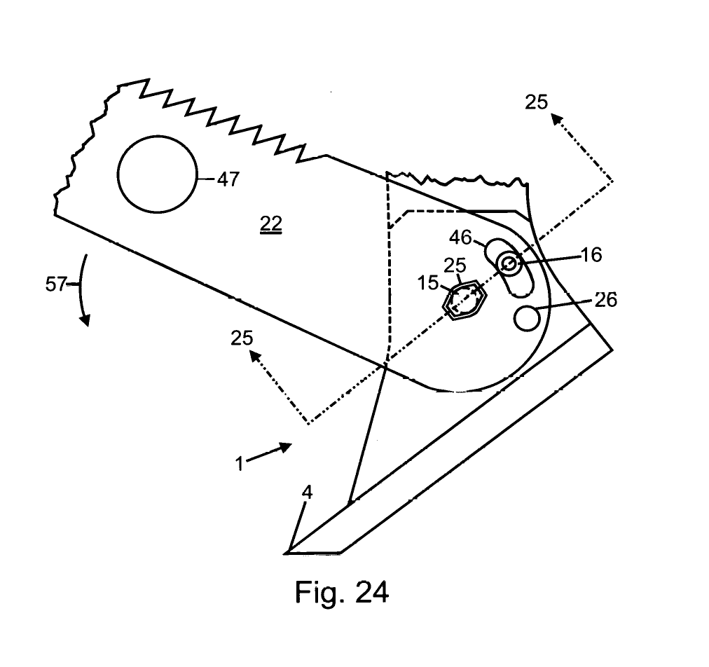

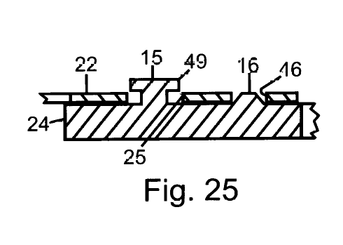

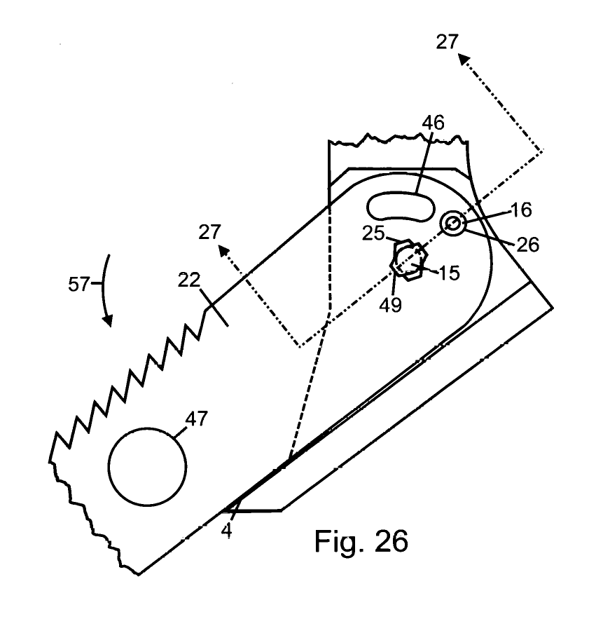

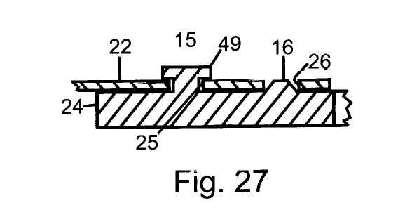

FIG. 2 is a left side exploded view of Polyfunctional Tool 1. The hammer body 23 may be attached to the main body 43 by a weld along phantom line C. The prying member body 24 may be attached to the main body 43 by a weld along phantom line D. The left side handle 20 and right side handle 21 may be attached to the main body 43 utilizing the screws 44 and bolts 45. The saw 22 may be attached to the Polyfunctional Tool 1 utilizing the saw mounting provision 15 as illustrated in FIG. 24, FIG. 25, FIG. 26 and FIG. 27.

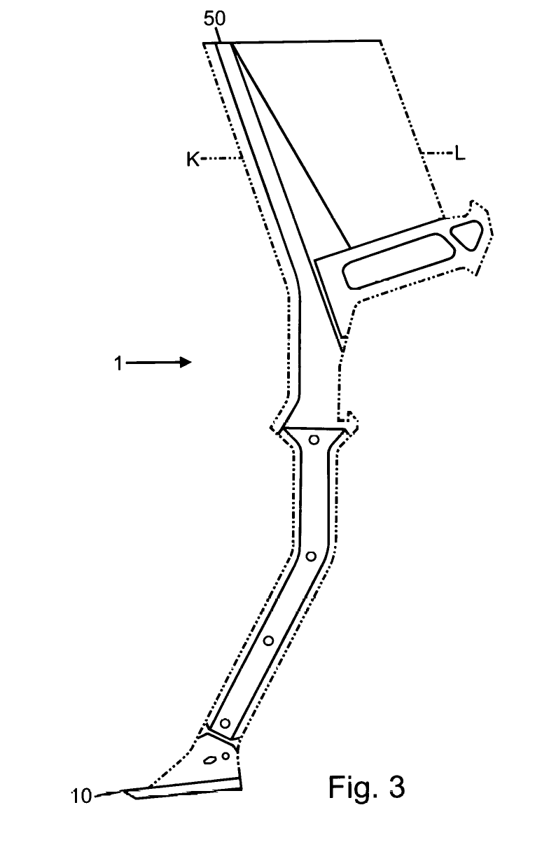

FIG. 3 is a left side view of the Polyfunctional Tool 1. As illustrated in FIG. 3, the Polyfunctional Tool 1 comprises a proximal end 10, distal end 50, forward portion K and rearward portion L.

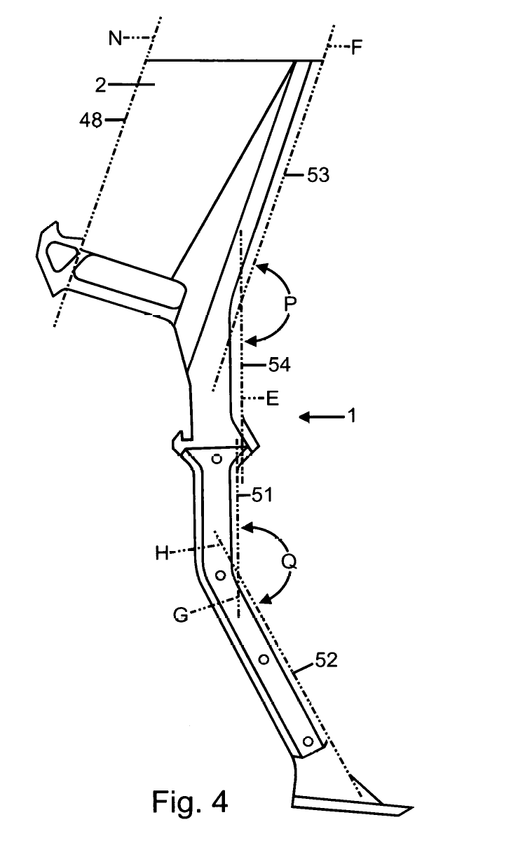

FIG. 4 is a right side view of the Polyfunctional Tool 1. FIG. 4 illustrates the first portion of the blade 54, second portion of the blade 53, first portion of the handle 51, second portion of the handle 52, line E, line F, line G, line H, Line N and line F. Line E extends along the first portion of the blade. Line F extends along the second portion of the blade. Line G extends along the first portion of the handle. Line H extends along the second portion of the handle. Line N extends along the rearward portion of the shovel. Line N is essentially parallel to line F. Angle P is the angle between line F and line E. Angle Q is the angle between line G and line H.

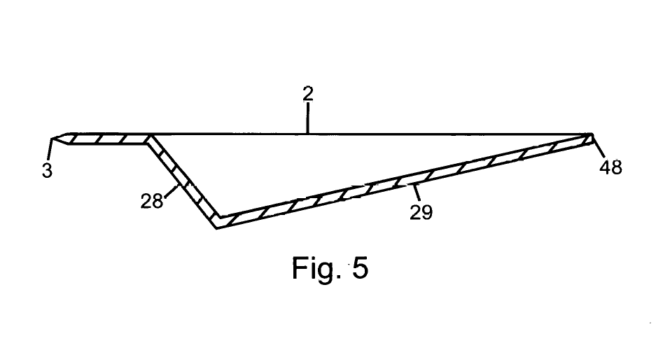

FIG. 5 is a sectional view further illustrating the conditions of FIG. 1. The shovel 2 is comprised of the first surface of the shovel head 28 and the second surface of the shovel head 29. As illustrated in FIG. 5, the first surface of the shovel head 28 and the second surface of the shovel head 29 extend in different directions such that the shovel 2 is provided a concave portion. This concave portion provides the shovel 2 the ability to more efficiently collect material to be shovelled 32 as known to the art.

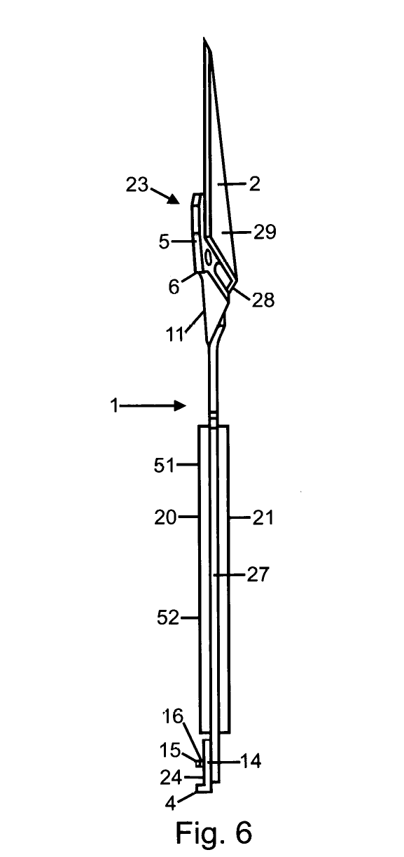

FIG. 6 is a rear view of the Polyfunctional Tool 1. As illustrated in FIG. 5 and FIG. 6, the first surface of the shovel head 28 and the second surface of the shovel head 29 provide the shovel 2 with a concave portion.

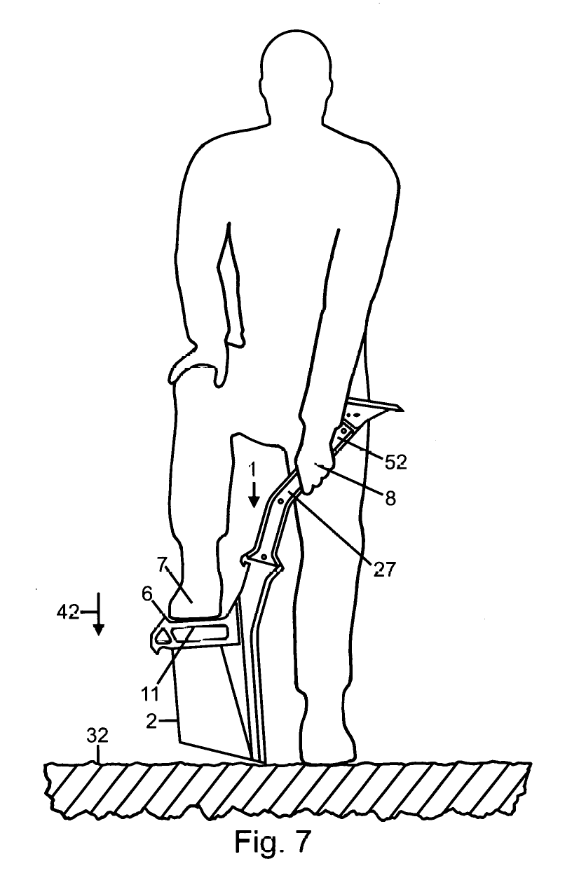

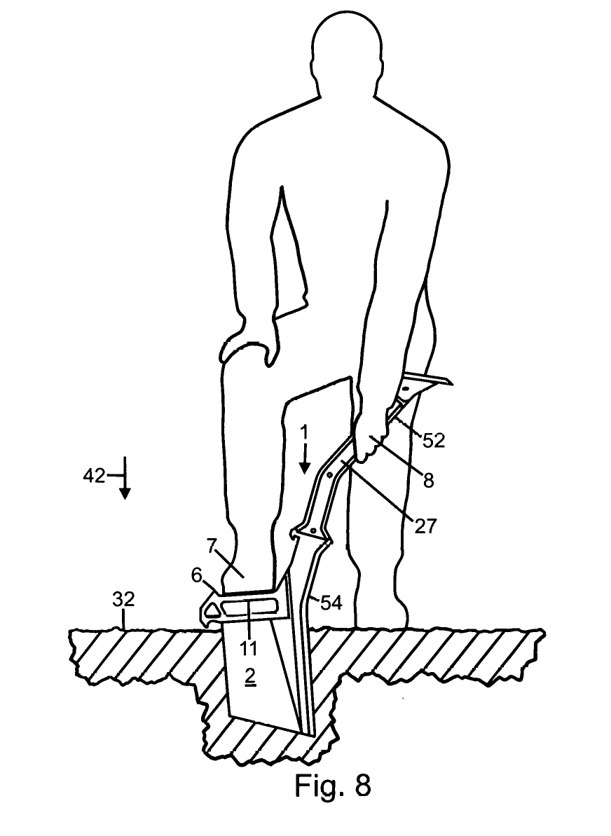

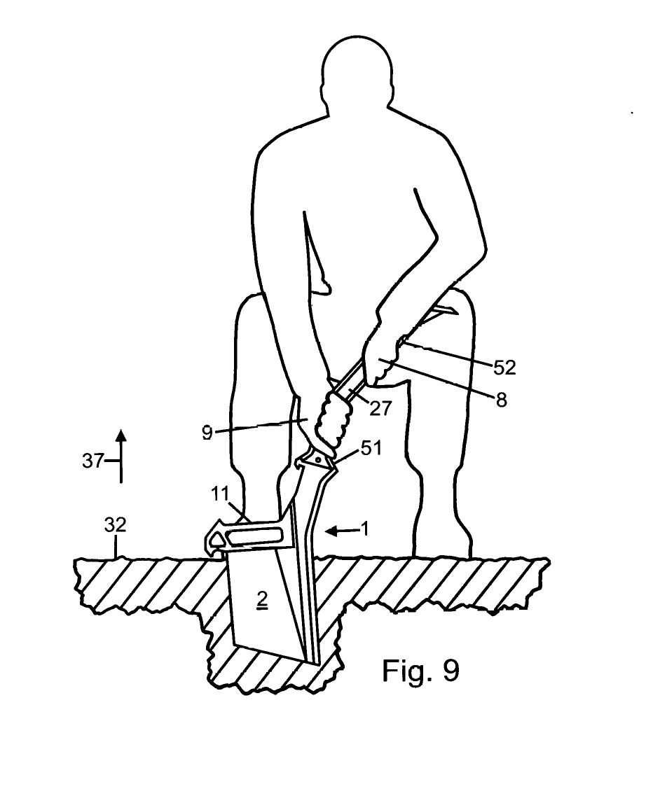

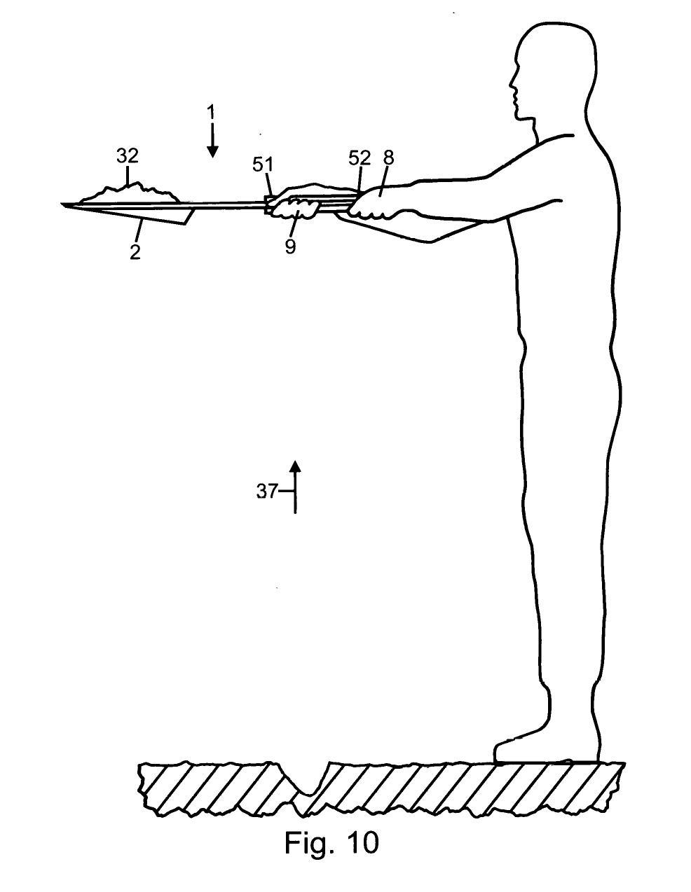

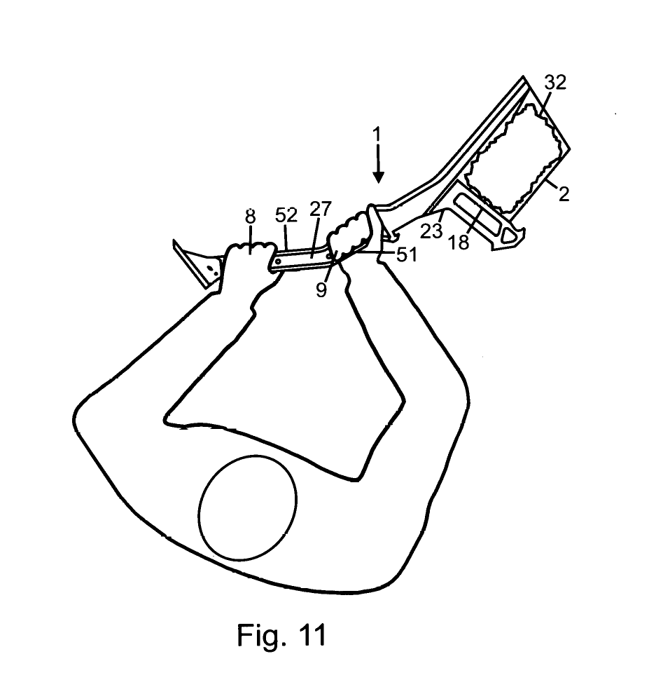

FIG. 7 is a left side view of the Polyfunctional Tool 1 and front view of the user which illustrates a first step of utilizing the Polyfunctional Tool 1 for the task of shoveling. In order to perform this first step, the user grips second portion of the handle 52 with his or her left hand 8. The user also places the shovel 2 upon the material to be shovelled 32 and engages the crossmember 11 with his or her foot 7. The rake 6 acts as a foot stop to prevent the user's foot 7 from sliding off of the crossmember 11. As illustrated in FIG. 7, FIG. 8, FIG. 9, FIG. 10 and FIG. 11, the Polyfunctional Tool 1 may be utilized for the task of shoveling.

FIG. 8 is a left side view of the Polyfunctional Tool 1 and front view of the user which illustrates a second step of utilizing the Polyfunctional Tool 1 for the task of shoveling. This second step of utilizing the Polyfunctional Tool 1 for shoveling takes place immediately after the conditions which are illustrated in FIG. 7. In order for this second step to be performed, the user has engaged the crossmember 11 with his or her foot 7 such that the Polyfunctional Tool 1 was displaced in the downward direction 42 from its previous position as illustrated in FIG. 7 to its current position as illustrated in FIG. 8. As illustrated in FIG. 8, this displacement of the Polyfunctional Tool 1 was such that the shovel 2 has been inserted into the material to be shovelled 32.

As illustrated in FIG. 8, insertion of the shovel 2 into the material to be shovelled 32 does not cause the material to be shovelled 32 to engage the first portion of the blade. Because the first portion of the blade is not engaged by the material to be shovelled, the sharpened edge of this first portion of the blade maintains its sharpness.

FIG. 9 is a left side view of the Polyfunctional Tool 1 and front view of the user which illustrates a third step of utilizing the Polyfunctional Tool 1 for the task of shoveling. This third step of utilizing the Polyfunctional Tool 1 for shoveling takes place immediately after the conditions which are illustrated in FIG. 8. In order for this third step to be performed, the user has gripped the first portion of the handle 51 with his or her right hand 9 and has gripped the second portion of the handle 52 with his or her left hand 8 such that the Polyfunctional Tool 1 may be forcefully manipulated with the user's arms. This manipulation of the Polyfunctional Tool 1 with the user's arms being such that the material to be shovelled 32 may be displaced by the shovel 2 from its position as illustrated in FIG. 9 to its position as illustrated in FIG. 10 as known to the art.

FIG. 10 is a front view of the Polyfunctional Tool 1 and left side view of the user which illustrates a fourth step of utilizing the Polyfunctional Tool 1 for the task of shoveling. This fourth step of utilizing the Polyfunctional Tool 1 for shoveling takes place immediately after the conditions which are illustrated in FIG. 9. In order to perform this fourth step, the user has displaced the Polyfunctional Tool 1 in the upward direction 37 from its previous position as illustrated in FIG. 9 to its current position as illustrated in FIG. 10, and therefore, has lifted a portion of the material to be shovelled 32 which is contained in the shovel 2 from essentially ground level to essentially abdomen level. As known to the art, this material to be shovelled 32 which is contained in the shovel 2 may be displaced by the user as required by his or her needs.

FIG. 11 is a left side view of the Polyfunctional Tool 1 and top view of the user which further illustrates the fourth step of utilizing the Polyfunctional Tool 1 for the task of shoveling. As illustrated in FIG. 11, the material to be shovelled 32 rests upon the shovel 2 and is prevented from falling off the rear of the shovel 2 by the material stop 18 of the hammer body 23.

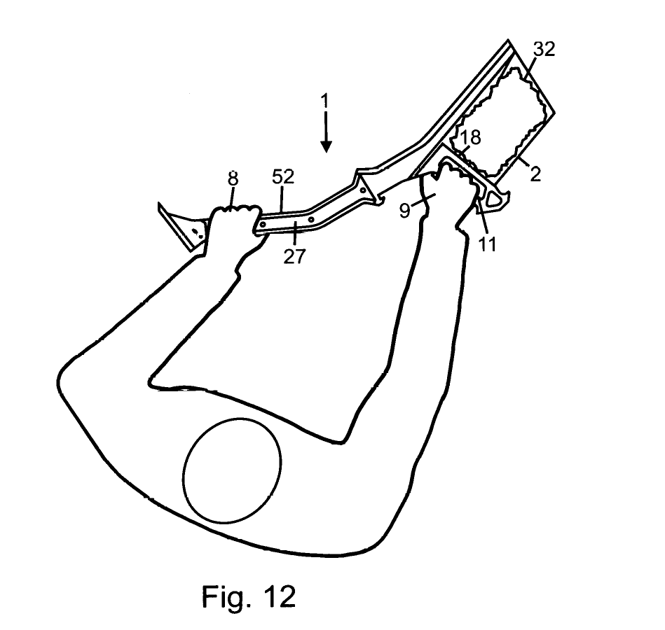

FIG. 12 is a left side view of the Polyfunctional Tool 1 and top view of the user which illustrates an alternate gripping method which may be performed by the user while utilizing the Polyfunctional Tool 1 for the task of shovelling. In this alternate gripping method, the user grips the second portion of the handle 52 with his or her left hand 8 and grips the crossmember 11 with his or her right hand 9. This alternate method of gripping the Polyfunctional Tool is advantageous in certain situations.

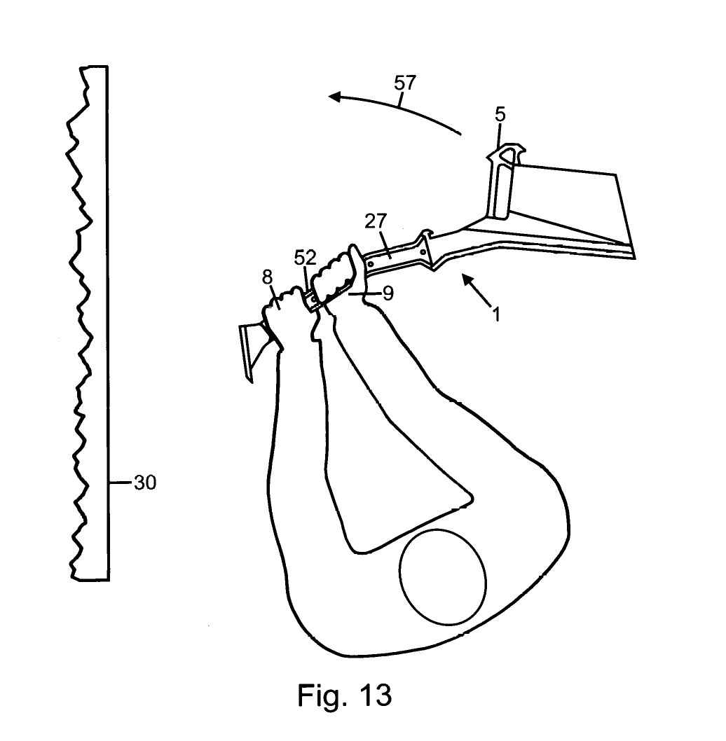

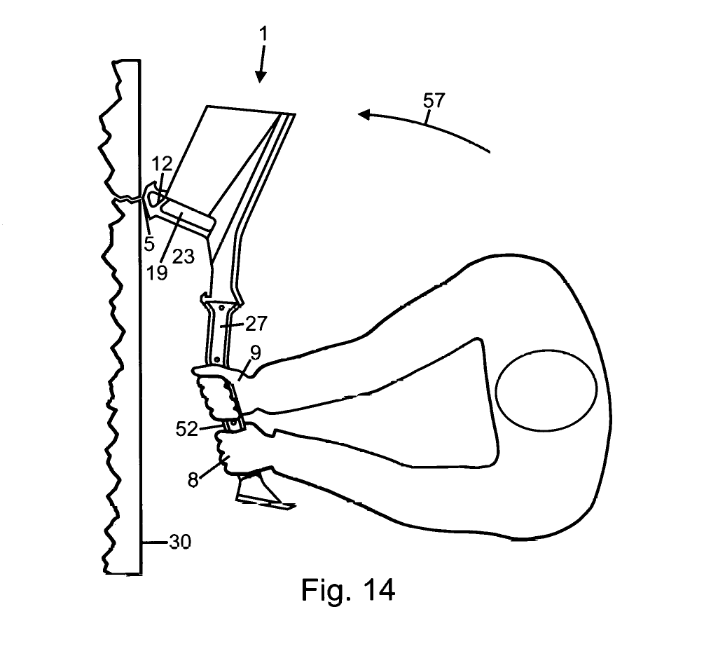

FIG. 13 is a right side view of the Polyfunctional Tool 1 and top view of the user which illustrates a first step of utilizing the Polyfunctional Tool 1 for the task of hammering. In order to perform this first step, the user grips the second portion of the handle 52 with his or her left hand 8 and right hand 9 such that the Polyfunctional Tool 1 may be urged in the counter-clockwise direction 57. As illustrated in FIG. 13 and FIG. 14, the Polyfunctional Tool 1 may be utilized for the task of hammering.

FIG. 14 is a right side view of the Polyfunctional Tool 1 and top view of the user which illustrates a second step of utilizing the Polyfunctional Tool 1 for the task of hammering. This second step of utilizing the Polyfunctional Tool 1 for hammering takes place immediately after the conditions which are illustrated in FIG. 13. In order to perform this second step, the user has urged the Polyfunctional Tool 1 in the counter-clockwise direction 57 from its previous position as illustrated in FIG. 13 to its current position as illustrated in FIG. 14 such that the hammer 5 of the Polyfunctional Tool 1 has impacted the wall 30. This impact of the hammer 5 of the Polyfunctional Tool 1 may cause objects to be damaged or destroyed. The hammer 5 of the Polyfunctional Tool 1 may alternately be used to perform non destructive tasks such as driving stakes into soil or driving nails into wood. Furthermore, the configuration of the finger hole 12 provides for a supportive structure which strengthens the hammer body 23 such that the hammer body 23 is not easily damaged by the impact of the hammer 5 upon various objects.

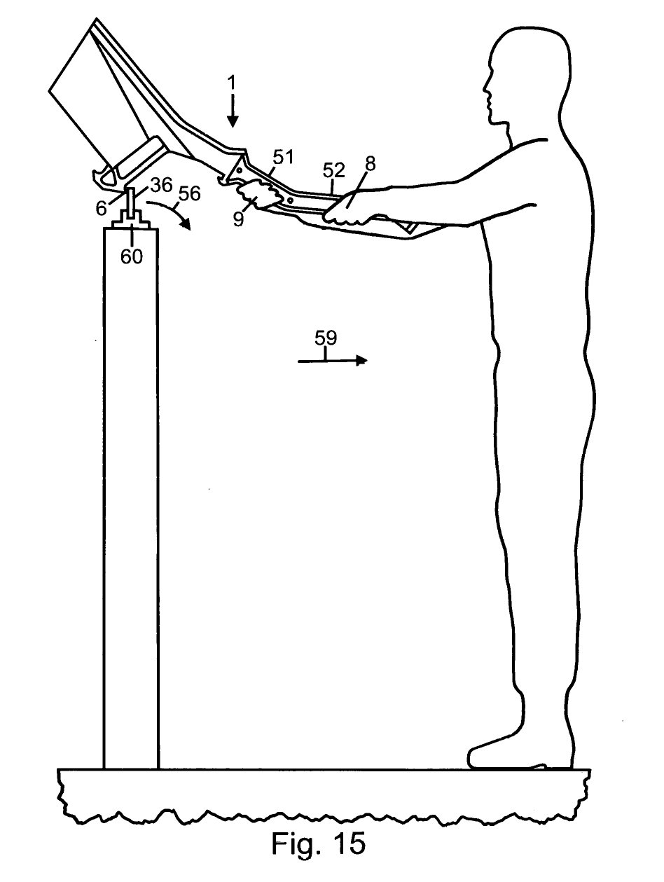

FIG. 15 is a right side view of the Polyfunctional Tool 1 and left side view of the user which illustrates the Polyfunctional Tool 1 being utilized for the function of raking. In order to perform the function of raking, the user first places the rake 6 into engagement with the window glass shard 36. After placing the rake 6 into engagement with the window glass shard 36, the user urges the Polyfunctional Tool 1 in the rearward direction 59. This urging of the Polyfunctional Tool 1 in the rearward direction 59 will cause the window glass shard 36 to be displaced in the clockwise direction 56 such that it will be removed from the window frame 60. This raking function has several uses including the dislodging and removal of window glass shards 36 from window frames 60 after the window has been broken utilizing the hammer 5 of the Polyfunctional Tool 1. This removal of window glass shards 36 from window frames 60 allows the user to cross window thresholds without being injured by window glass shards 36.

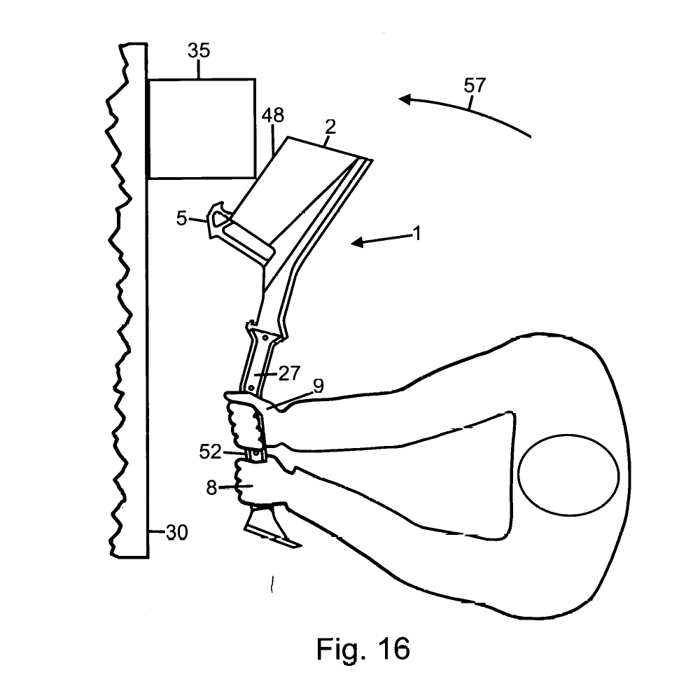

FIG. 16 is a left side view of the Polyfunctional Tool 1 and top view of the user which illustrates the rearward portion of the shovel 48 having impacted an obstruction 35 as the user attempted to impact the wall 30 with the hammer 5. Proper usage of the present invention for the task of hammering involves the user gripping the second portion of the handle 52. As illustrated in FIG. 16, this gripping of the second portion of the handle 52 causes the rearward portion of the shovel 48 to be inclined at a significant angle. This incline of the rearward portion of the shovel 48 allows the rearward portion of the shovel 48 to deflect a significant portion of the impact force which would otherwise be transmitted into the shovel due to the rearward portion of the shovel 48 impacting the obstruction 35, and therefore, damage to the rearward portion of the shovel 48 from its impacting the obstruction 35 is minimized.

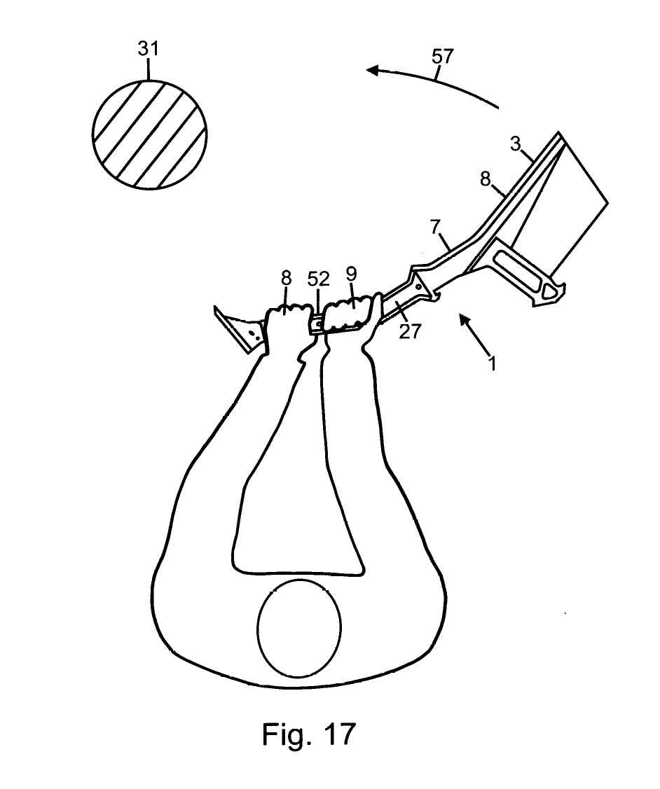

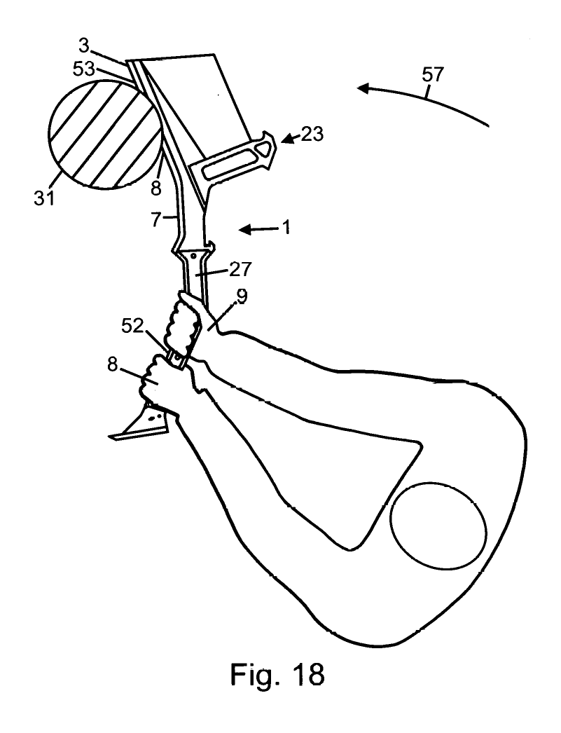

FIG. 17 is a left side view of the Polyfunctional Tool 1 and top view of the user which illustrates a first step of utilizing the Polyfunctional Tool 1 for the task of cutting or chopping. In order to perform this first step, the user has gripped the second portion of the handle 52 with his or her left hand 8 and right hand 9 such that the Polyfunctional Tool 1 may be urged in the counter-clockwise direction 57. As illustrated in FIG. 17 and FIG. 18, the Polyfunctional Tool 1 may be utilized for the task of cutting or chopping.

FIG. 18 is a left side view of the Polyfunctional Tool 1 and top view of the user which illustrates a second step of utilizing the Polyfunctional Tool 1 for the task of cutting or chopping. This second step of utilizing the Polyfunctional Tool 1 for cutting or chopping takes place immediately after the conditions which are illustrated in FIG. 17. In order to perform this second step, the user has urged the Polyfunctional Tool 1 in the counter-clockwise direction 57 such that the blade 3 of the Polyfunctional Tool 1 is caused to impact the tree 31. Repeated impacts of the blade 3 upon the tree 31 may cause the tree 31 to be felled, such that the blade 3 of the Polyfunctional Tool 1 may essentially function as an axe. The additional weight the hammer body 23 provides in the proximity of the second portion of the blade 53 increases the chopping ability of the blade 3. The blade 3 is comprised of a first portion of the blade 54 and a second portion of the blade 53. This first portion of the blade 54 and a second portion of the blade 53 together providing a convex portion of the blade 3. This convex portion of the blade 3 provides the user increased cutting ability as known to the art. Similar convex angled bladed instruments and their benefits in increasing cutting ability are known to the art. The blade 3 of the Polyfunctional Tool 1 may alternately be used to perform cutting tasks such as cutting rope, and in particular, the first portion of the blade 54 is well suited for cutting tasks as its sharpened edge is not dulled due to engaging material to be shovelled 32.

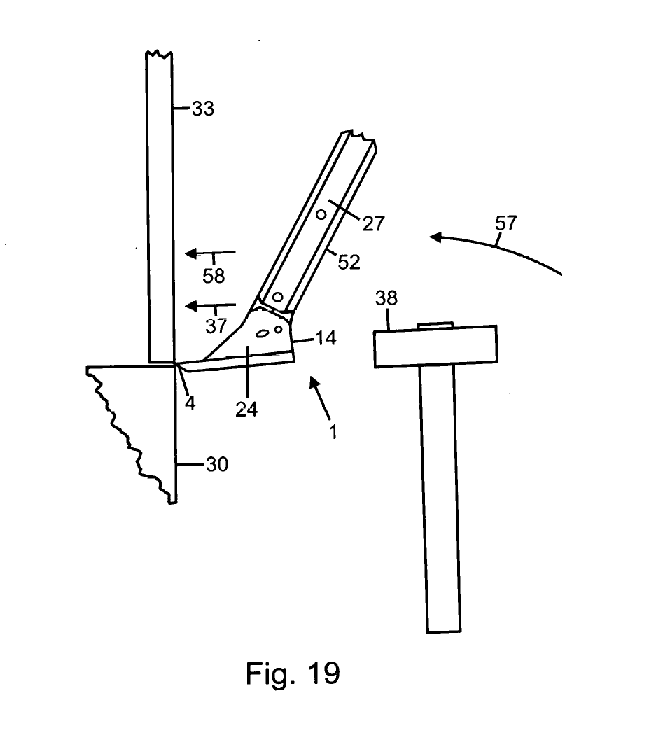

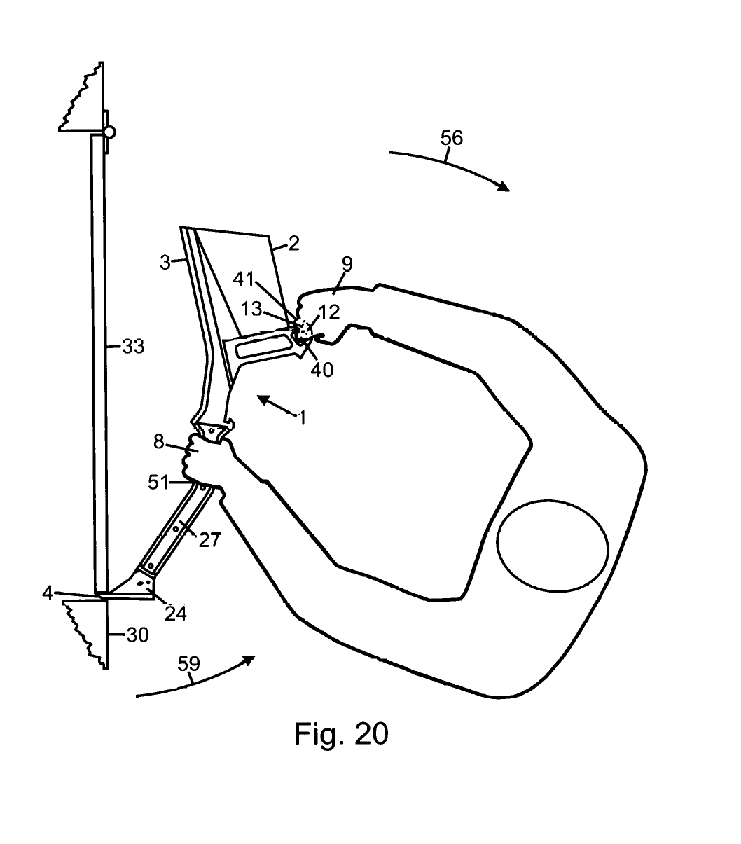

FIG. 19 is a partial left side view of the Polyfunctional Tool 1 which illustrates a technique utilized to properly seat the prying member 4 between the wall 30 and the door 33 as a first step in utilizing the Polyfunctional Tool 1 for the task of prying. This first step is only required in instances where the prying member 4 is impeded from being properly inserted between the wall 30 and the door 33. As illustrated in FIG. 19, in order that the prying member 4 be properly seated between the wall 30 and the door 33, a hammering implement 38 is urged in the counter-clockwise direction 57 such that the hammering implement 38 engages the hammering surface 14. This engagement between the hammering implement 38 and the hammering surface 14 being such that the prying member 4 is displaced in the forward direction 58 from its position as illustrated in FIG. 19 to its position as illustrated in FIG. 20. As illustrated in FIG. 20, this displacement of the prying member 4 being such that the prying member 4 is properly inserted between the wall 30 and the door 33. As illustrated in FIG. 19, FIG. 20 and FIG. 21, the Polyfunctional Tool 1 may be utilized for the task of prying.

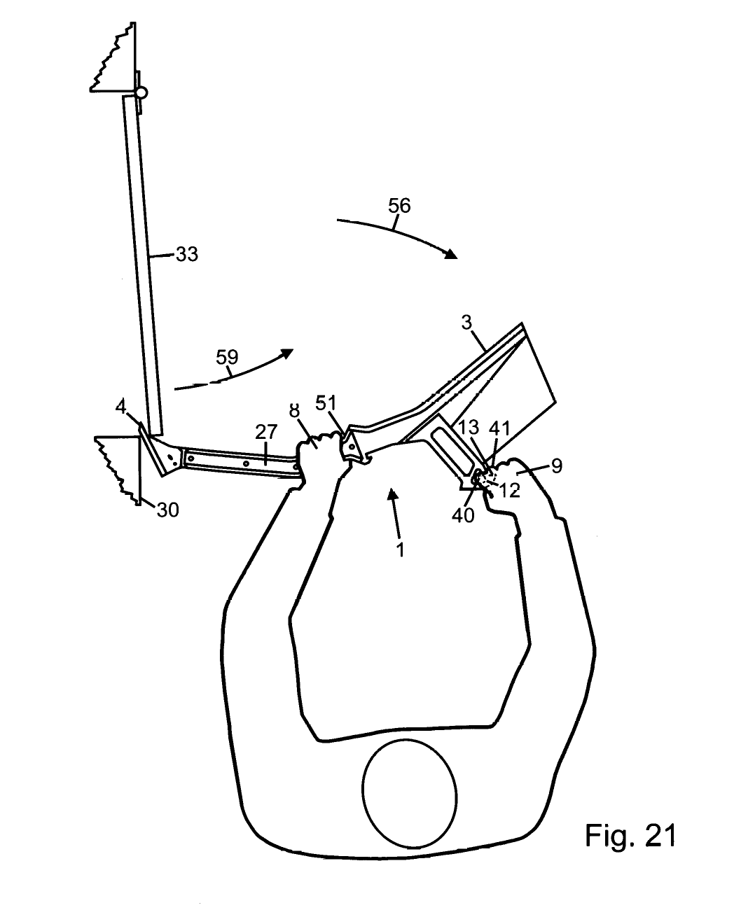

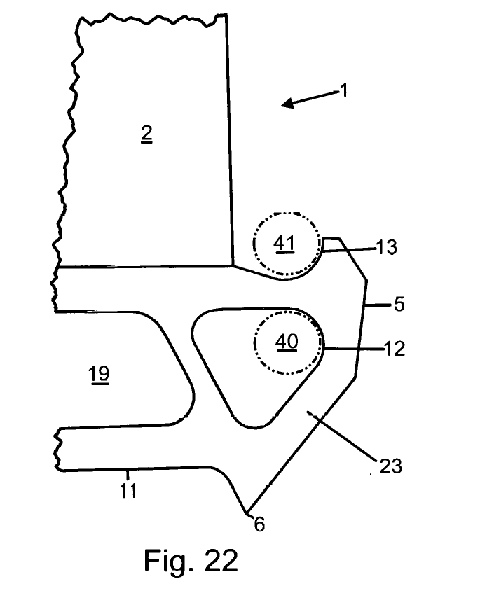

FIG. 20 is a left side view of the Polyfunctional Tool 1 and top view of the user which illustrates a second step of utilizing the Polyfunctional Tool 1 for the task of prying. This second step of utilizing the Polyfunctional Tool 1 for prying takes place immediately after the conditions which are illustrated in FIG. 19. In order to perform this second step, the user has gripped the first portion of the handle 51 with his or her left hand 8 and has engaged the hammer body 23 with his or her right hand 9. This engagement between the user's right hand 9 and the hammer body 23 being such that the user's first finger 40 engages the finger hole 12 and the user's second finger 41 engages the finger surface 13. This engagement between user's first finger 40, finger hole 12, user's second finger 41 and the finger surface 13 is further illustrated in FIG. 22.

FIG. 21 is a left side view of the Polyfunctional Tool 1 and top view of the user which illustrates a third step of utilizing the Polyfunctional Tool 1 for the task of prying. This third step takes place immediately after the conditions which are illustrated in FIG. 20. In order to perform this third step, the user has urged the Polyfunctional Tool 1 in the clockwise direction 56. As illustrated in FIG. 21, this urging of the Polyfunctional Tool 1 in the clockwise direction 56 has caused the door 33 to be displaced in the counter-clockwise direction 59 from its previous position as illustrated in FIG. 20 to its current position as illustrated in FIG. 21. The placement of the blade 3 on the forward portion K of the Polyfunctional Tool 1 and the finger hole 12 and finger surface 13 on the rearward portion L of the Polyfunctional Tool 1 provides the benefit of a decreased likelihood of injury to the user during the task of prying. As illustrated in FIG. 20 and FIG. 21, this decrease in the likelihood of injury is due to the blade 3 facing away from the user as the user urges the Polyfunctional Tool 1 towards his or herself during the prying function, and therefore, the user does not place his or herself in danger of being impacted by the blade 3. The placement of the prying member 4 upon the proximal end 10 of the polyfunctional tool 1 provides benefits to the user as this placement extends the reach of the prying member 4 such that the prying member 4 is able to reach inside recesses.

FIG. 22 is a partial left side view of the Polyfunctional Tool 1 further illustrating the conditions of FIG. 20 and FIG. 21. In particular, FIG. 22 further illustrates the engagements between the user's first finger 40, user's second finger 41, finger hole 12 and finger surface 13.

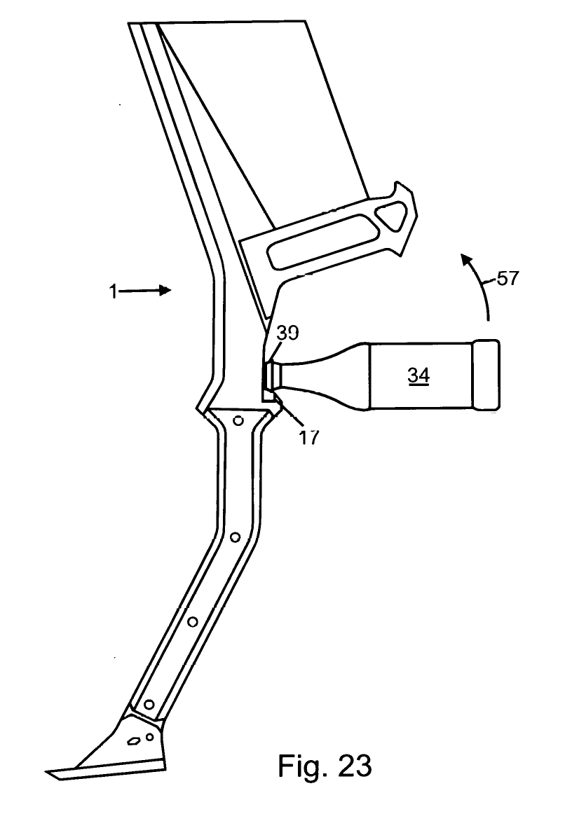

FIG. 23 is a left side view of the Polyfunctional Tool 1 being utilized for the task of bottle opening. In order to utilize the Polyfunctional Tool 1 for the task of bottle opening, the user places the bottle cap 39 of a bottle 34 into engagement with the bottle opener 17 and urges the bottle 34 in the counter-clockwise direction 57 such that the bottle cap 39 will be removed from the bottle 34.

FIG. 24 is a partial left side view of the Polyfunctional Tool 1 illustrating a first step of the user attaching the saw 22 to the Polyfunctional Tool 1. As illustrated in FIG. 24, in order for the user to attach the saw 22 to the Polyfunctional Tool 1, the user has placed the saw 22 upon the left side of the Polyfunctional Tool 1 such that the saw mounting provision 15 is properly inserted into the saw mounting provision hole 25. This in turn causes the saw locking provision 16 to fall within the saw locking provision clearance slot 46. A multitude of saw blades may be attached to the Polyfunctional Tool 1, including wood cutting saw blades and metal cutting saw blades. As illustrated in FIG. 24 through FIG. 27, a saw blade may be attached to the Polyfunctional Tool 1.

FIG. 25 is a partial sectional view further illustrating the conditions of FIG. 24. FIG. 25 depicts the saw mounting provision 15, saw locking provision 16, saw holding tabs 49, saw 22, saw locking provision clearance slot 46, main body 43 and prying member body 24.

FIG. 26 is a partial left side view of the Polyfunctional Tool 1 illustrating a second step of the user attaching the saw 22 to the Polyfunctional Tool 1. This second step takes place immediately after the conditions which are illustrated in FIG. 24. In order to perform this second step, the user, with one of his or her hands, grips the saw manipulation hole 47 and urges the saw 22 in the counter-clockwise direction 57 such that the saw 22 is displaced from its previous position as illustrated in FIG. 24 to its current position as illustrated in FIG. 26. This displacement of the saw 22 from its previous position as illustrated in FIG. 24 to its current position as illustrated in FIG. 26 causes the saw locking provision 16 to engage the saw locking provision hole 26. Furthermore, this displacement of the saw 22 from its previous position as illustrated in FIG. 24 to its current position as illustrated in FIG. 26 causes saw holding tabs 49 to engage the saw 22 such that the saw 22 is firmly held against the Polyfunctional Tool 1. Finally, this displacement of the saw 22 from its previous position as illustrated in FIG. 24 to its current position as illustrated in FIG. 26 causes the saw 22 to engage the prying member 4 such that continued displacement of the saw 22 in the counter-clockwise direction 57 is arrested. The aforementioned engagements cause the saw 22 to be held firmly in its position with respect to the Polyfunctional Tool 1 as illustrated in FIG. 26 such that the user may utilize the saw 22.

FIG. 27 is a partial sectional view further illustrating the conditions of FIG. 26. FIG. 27 depicts the saw mounting provision 15, saw locking provision 16, saw holding tabs 49, saw 22, saw locking provision hole 26, main body 43 and prying member body 24. As illustrated in FIG. 27, the saw holding tabs 49 of the saw mounting provision 15 engage the saw 22 such that the saw 22 is firmly held against the prying member body 24. Furthermore, the saw locking provision 16 has engaged the saw locking provision hole 26 such that the saw 22 is properly secured unto the polyfunctional tool 1.

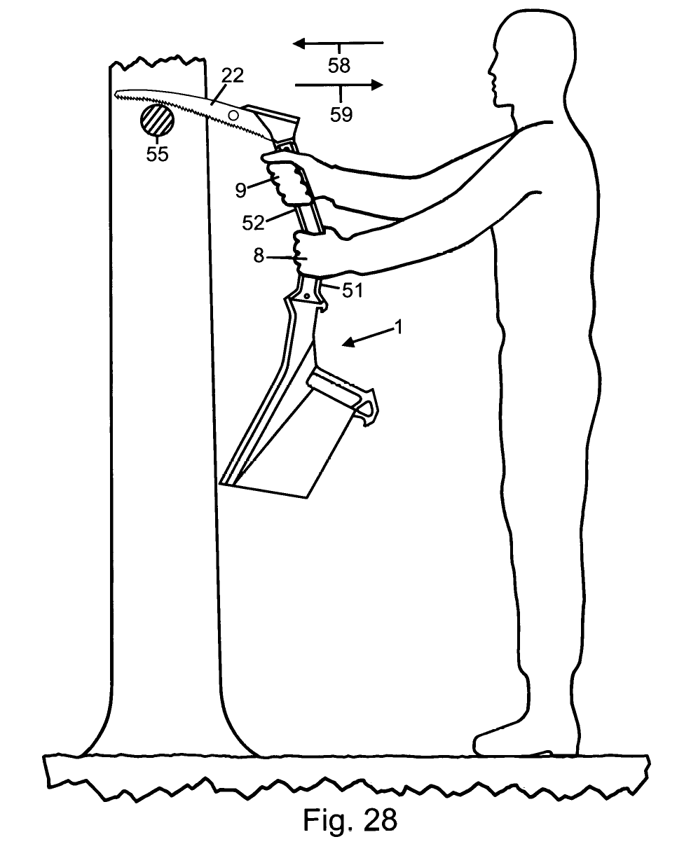

FIG. 28 is a right side view of the Polyfunctional Tool 1 and left side view of the user which illustrates the Polyfunctional Tool 1 being utilized for the function of sawing. In order to perform the function of sawing, the user first places the saw 22 into engagement with the object to be sawed 55. While maintaining engagement between the saw 22 and the object to be sawed 55, the user first urges the Polyfunctional Tool 1 in the forward direction 58 and then in the rearward direction 59, and as known to the art, and repeats this process until the desired effect on the object to be sawed 55 is achieved. Because the saw 22 is detachable as illustrated in FIG. 24 through FIG. 27, either a saw 22 that is configured to cut wood or a saw 22 that is configured to cut metal may be attached to the Polyfunctional Tool such that the desired effect upon the object to be sawed 55 may be achieved whether the object to be sawed 55 is composed of wood or metal. This saw mounting provision 15 being configured such that the sharpened edge of the blade 3 is oriented away from the user such that increased safety is provided for the user as he or she utilizes this sawing function.

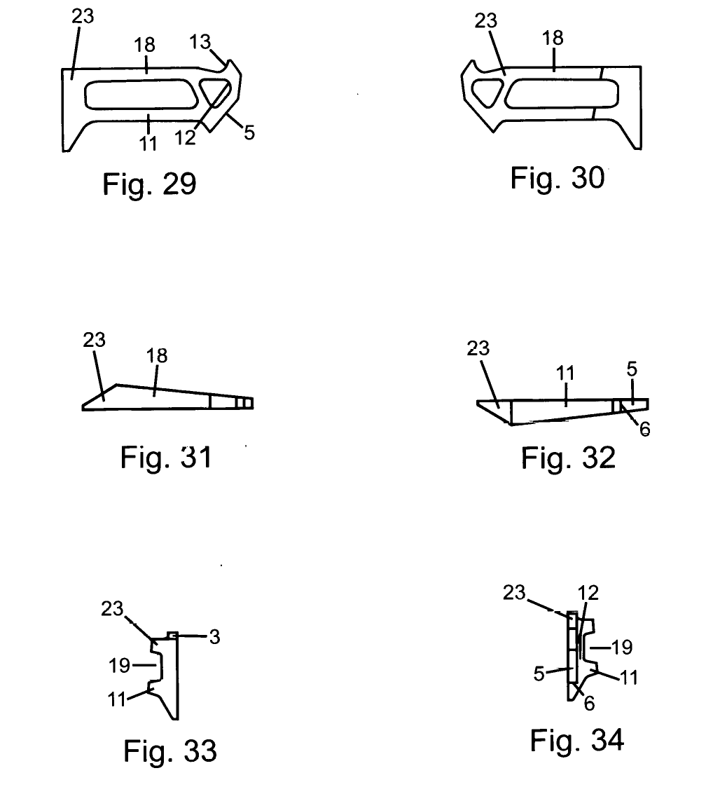

FIG. 29 is a left side view of the hammer body 23.

FIG. 30 is a right side view of the hammer body 23.

FIG. 31 is a top view of the hammer body 23.

FIG. 32 is a bottom view of the hammer body 23.

FIG. 33 is a front view of the hammer body 23.

FIG. 34 is a rear view of the hammer body 23.

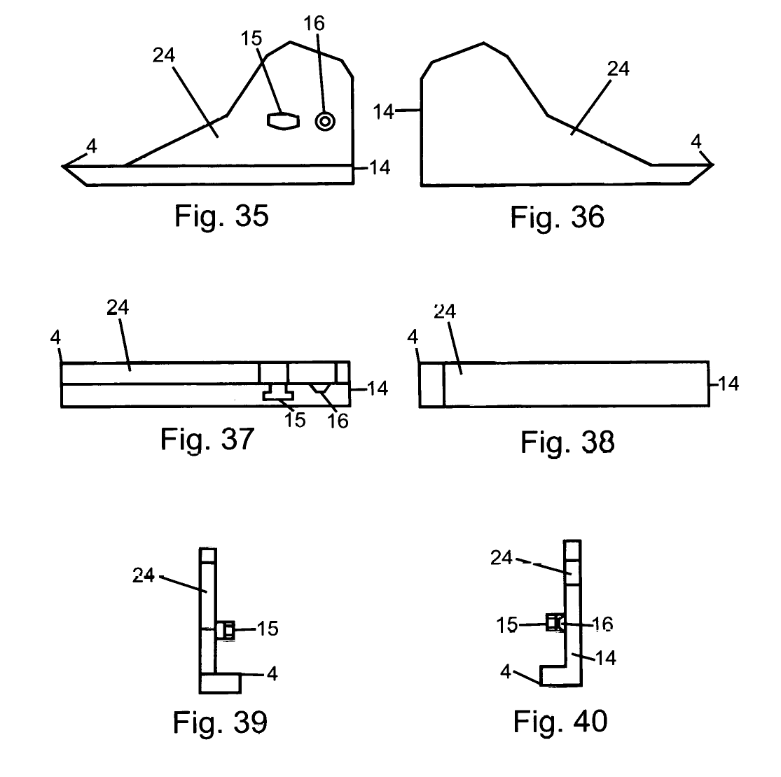

FIG. 35 is a left side view of the prying member body 24.

FIG. 36 is a right side view of the prying member body 24.

FIG. 37 is a top view of the prying member body 24.

FIG. 38 is a bottom view of the prying member body 24.

FIG. 39 is a front view of the prying member body 24.

FIG. 40 is a rear view of the prying member body 24.

### DESCRIPTION OF ONE EXEMPLARY EMBODIMENT

The present invention may be embodied in other specific forms without departing from its structures, methods, or other essential characteristics as broadly described herein and claimed hereinafter. The described embodiments are to be considered in all respects only as illustrative, and not restrictive. The scope of the invention is, therefore, indicated by the appended claims, rather than by the foregoing description. All changes that come within the meaning and range of equivalency of the claims are to be embraced within their scope. The present invention may be embodied in other specific forms without departing from its spirit or essential characteristics. All of the parts discussed above may be made of metal, composite, or plastics. In addition, the parts may be stamped, extruded, molded, cast, forged, or machined. The described embodiments are to be considered in all respects only as illustrative and not restrictive. All changes and alternatives that would be known to one of skill in the art are embraced within the scope of the invention.

One exemplary embodiment of the present invention is the Polyfunctional Tool 1 as illustrated in the figures. The Polyfunctional Tool 1 may be manufactured in a similar manner to that o state of the art bladed instruments, however, certain modifications of the typical manufacturing process may be required. The main body 43 of the Polyfunctional Tool 1 may be constructed from a wide variety of materials, but steel is particularly well suited for this task, as steel construction provides for ease of manufacture and high durability.

A wide variety of steels known to the art may be utilized to manufacture the main body 43, but in particular, cold-rolled high-carbon steel plate is well suited for this task. A blank essentially conforming to the basic outline of the main body 43 as illustrated in FIG. 2 may be manufactured by laser cutting a steel plate of proper thickness. After this blank is laser cut from the steel plate, a die may be used to stamp this blank such that the first surface of the shovel head 28 and the second surface of the shovel head 29 are formed onto the shovel such that this blank properly takes the form of the main body 43 as illustrated in the figures. Other embodiments of the present invention exist in which a cross sectional view of the shovel 2 varies from that illustrated in FIG. 5. These alternate embodiments of the shovel 2 include embodiments in which more than two bends are utilized to produce the aforementioned concavity. Furthermore, alternate embodiments of the shovel 2 exist where the aforementioned concavity is comprised of a singular curved surface rather than multiple bends.

The hammer body 23 is well suited for being manufactured by forging. Manufacture of the hammer body 23 utilizing a steel forging would provide for long life and a high resistance to impact damage. After the basic shape of the hammer body 23 is forged from steel, the forging would then be machined utilizing a CNC mill such that a proper dimensions are provided for the hammer body 23 to be attached to the main body 43. The prying member body 24 is well suited for being manufactured by laser cutting steel plate of sufficient thickness to produce a blank.

This laser cutting process producing a blank having the basic outline of the prying member body 24 as illustrated in FIG. 2 such that the prying member 4 and hammering surface 14 are essentially formed by this laser cutting process. This blank would then be machined utilizing a CNC mill such that the saw mounting provision 15, saw locking provision 16 and proper dimensions of the prying member 4 are provided. The hammer body 23 may be welded onto the main body 43 along a weld line as illustrated by Phantom line C in FIG. 2. The prying member body 24 may be welded onto the main body 43 along a weld line as illustrated by Phantom line D in FIG. 2. The welding process known as TIG welding would be particularly well suited for performing the necessary welds. The hammer body 23 and prying member body 24 may alternatively be attached to the main body 43 by rivet or screw attachment methods as known to the art.

After the hammer body 23 and prying member body 24 are welded onto the main body 43 to create a weldment, this weldment may be heat treated in order that proper rigidity is imparted unto the weldment. After this heat treatment, the weldment may be sand-blasted, parkerized and painted as an anti-corrosion treatment. After the paint has sufficiently dried, the blade 3 as illustrated in FIG. 2 may be created by removing material from the weldment with a grinder such that a blade 3 of proper profile is provided. The grinding process may also be utilized to create a sharpened edge around the perimeter of the shovel 2. After the grinding of the blade 3, the left side handle 20 and the right side handle 21 may be attached unto the main body 43 utilizing screws 44 and bolts 45. The left side handle 20 and the right side handle 21 may be manufactured from CNC machined G10 laminate material as known to the art, or alternatively, from any number of suitable handle materials as known to the art including but not limited to elastomers, thermoplastics, carbon fiber and composites. The saw 22 may be manufactured from sheet steel which is then laser cut to form a blank. After laser cutting this blank, the completed saw 22 is created by properly grinding saw teeth unto this blank. The saw 22 may be manufactured in various configurations to permit the efficient sawing of different material types as known to the art, these configurations including a saw 22 with wood cutting saw teeth and metal cutting saw teeth. This description is made in terms exemplary and alternative embodiments, and is not intended to be so limited.

I claim:

1. A multifunction tool comprising:
a main body, said main body comprising a proximal end, a distal end, a forward portion and a
rearward portion; and
a prying member deposed along said proximal end; and
a handle extending from about said proximal end towards said distal end; and
a blade defined along part of said forward portion; and
a shovel deposed along said distal end.
